(19) United States
(12) Patent Application Publication
(10) Pub. No.: US 2006/0133196 A1
(43) Pub. Date: Jun. 22, 2006

(54) Non-aerating agitation system

(76) Inventor: Bruce Byers, Brighton, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/312,011

(22) Filed: Dec. 20, 2005

Related U.S. Application Data
(60) Provisional application No. 60/639,224, filed on Dec. 22, 2004.

(51) Int. Cl. B01F 7/26

(52) U.S. Cl. 366/289; 366/316

(57) ABSTRACT

A non-aerating agitator system for mixing fluids within an interior volume defining vessel. An agitator plate is supported in inwardly extending and reciprocating fashion within the vessel interior and includes a pair of openings defined therethrough. A pair of displaceable valves selectively overlap and are displaced from the plate defined openings, in order to establish one-way fluid valves and which are operable to allow fluid to pass through the associated openings in a first linearly deflecting direction, while being sealed shut to prevent fluid passage therethrough in a second direction opposite the first direction. A reciprocating drive, such as a pneumatically operated motor, linearly translates the plate in each of first and second directions.

### CROSS REFERENCE TO RELATED APPLICATIONS

The present application claims the priority of U.S. Provisional Patent application Ser. No. 60/639,224 filed Dec. 22, 2004, and entitled Non-Aerating Agitation System.

### BACKGROUND OF THE INVENTION

1. Field of the Invention

This invention relates generally to mixing systems. More specifically, the present invention discloses an apparatus for mixing paint and other fluids wherein aeration of the mixed fluid is minimized or avoided through the application of an inner extending and reciprocating agitation plate incorporating a trapdoor valve, permitting fluid in one direction only and in order to enhance the agitation effect of the device.

2. Description of the Prior Art

Many products, including paints, food products, and other chemical compositions, need to be mixed or otherwise agitated in connection with their formulation, storage or use. In many instances, fluids are agitated by means of paddles, blades, screws or other such devices.

However, it has been found that aeration of fluids during mixing can cause significant problems. For example, dissolved air can oxidize or otherwise chemically interfere with the stability and/or function of various fluids.

In particular, it has been found that the presence of air in paints can adversely affect the rheology (i.e., the study of deformation and flow of fluid) of the paint or other viscous fluid, thereby interfering with paint flow and, hence, application operations. In addition, retained air can produce bubbles, which result in defects in the painted surface, and the presence of air can oxidize various components of a paint formulation.

In view of the above, the relevant industry has been turning more and more to the use of water-based formulations for the painting of vehicles and other articles of manufacture. It has been found that problems of aeration are significantly greater in connection with such water-based materials than is the case with oil-based paints/fluids.

A first example of one prior art device is set forth in U.S. Pat. No. 5,813,760, issued to Strong, and which teaches an agitator for a paint mix tank characterized by a paddle exhibiting a plurality of passages extending between opposite sides thereof. The paddle is reciprocated up and down within a tank in linear directions generally along paths through its passages. Reciprocation is provided by a motor operating through a gearbox, the speed of the motor being adjustable to control the reciprocation rate of the paddle. The passages through the paddle are calculated to improve its agitation performance and enable its linear speed to be maintained sufficiently low during agitation of the paint to eliminate foaming of an entrapment of air in the paint.

U.S. Pat. No. 5,533,802, issued to Garganese, discloses an improved paint can assembly which permanently replaces an original paint can lid. The accessory includes a main body with three apertures defined therein. A first aperture is circular shaped and provides access by a siphon hose from paint spraying machines. A second semicircular shaped aperture receives an insert having a pouring spout to permit controlled pouring of liquid contained in the container. A third aperture receives a mixing shaft which is connected to a mixing plate to mix liquid within the container. A handle facilitates actuation of the mixing shaft and, by its rotational position, ensures that the mixing plate is properly positioned while preventing overflow of the liquid contained therein.

U.S. Pat. No. 6,582,117, to Rogers et al., teaches a paint mixing device exhibiting a planar mixing head disposed parallel to a bottom wall of the container and a limb which extends perpendicularly from a peripheral edge region of the mixing head adjacent to the container side wall. A coupling is located in the container and provides releasable connection to an external handle by which the mixing device is reciprocated vertically to agitate and mix the container contents.

U.S. Patent Application Publication 2002/0196704, to May, teaches a perforated plate churn mixer utilized to wet and disperse small sized particle solids within a liquid and to also provide a wide range of shear levels to insure the break-up of any remaining agglomerates and the uniformity of the mixture. A mixing vessel includes a perforated plate oscillating within and to force the solids and liquids to pass repeatedly through the perforations in the plate and the clearance between the plate and the walls of the vessel. The perforated plate is attached to a rod which that is oscillated by external equipment and passes through an airtight seal in the lid of the vessel, the lid further including an openable/closable vent.

Finally, U.S. Pat. No. 4,401,268, issued to Pomponi, Jr., discloses an improved spray gun assembly including a fluid supply container connected to a spray gun and manually operable trigger for actuating the spray gun. A motor driven agitator automatically agitates the fluid contents of the supply container. The agitator is driven by an air motor, and includes a paddle which is reciprocated in the fluid contents in directions perpendicular to the plane in which it lies.

Accordingly, there is a need for an agitation system, which can be implemented to mix paints and other such fluids without causing aeration, this symptomatic with prior art devices. The system should be simple to operate and clean, and it should be readily retrofittable into presently employed fluid handling equipment. As will be explained in detail hereinbelow, the present invention provides an agitator system which fulfills these needs.

### SUMMARY OF THE PRESENT INVENTION

The present invention discloses a non-aerating agitator system for mixing fluids and which includes a vessel defining an interior fluid volume. An agitator plate is supported in inwardly extending and reciprocating fashion within the vessel interior and includes at least one, and preferably a pair of openings defined therethrough.

A pair of displaceable valves selectively overlap and are displaced from the plate defined openings, in order to establish one-way fluid valves and which are operable to allow fluid to pass through the associated openings in a first linearly deflecting direction, while being sealed shut to prevent fluid passage therethrough in a second direction opposite the first direction. A reciprocating drive, such as a pneumatically operated motor, linearly translates the plate in each of first and second directions.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of the agitation plate incorporated into the non-aerating system according to the present invention;

FIG. 2 is a side elevational view of the agitation plate according to FIG. 1 and further illustrating the trapdoor valves in an extended and fluid passage condition consistent with a downward linear travel associated with the reciprocating plate;

FIG. 3 is a top plan view of the agitation plate illustrated in FIG. 1; and

FIG. 4 is an environmental plan view of the non-aerating agitating system incorporated into a sealable fluid holding vessel, and further illustrating in partial cutaway the linear reciprocating travel characteristics of the agitating plate.

### DETAILED DESCRIPTION OF THE PREFERRED EMBODIMENTS

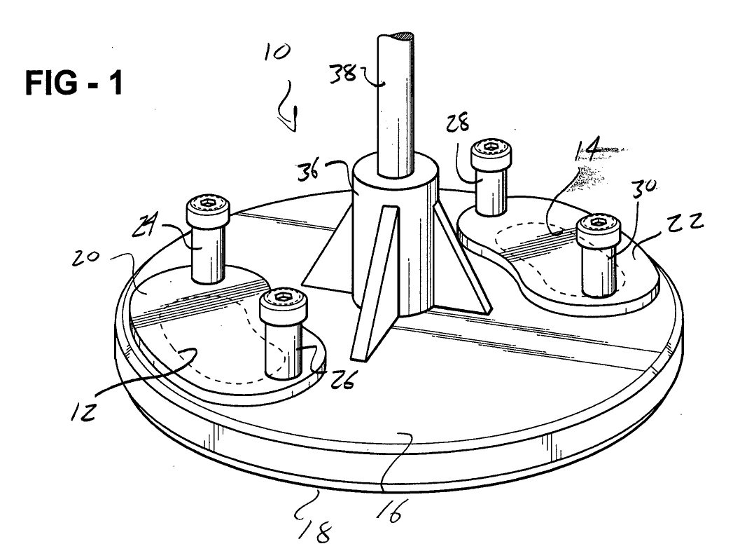

Referring now to FIG. 1-4, the present invention discloses a unique plate configuration 10 incorporated into an in-vessel agitation system. As described previously, the present invention is capable of mixing paints and other fluids in an even and non-aerating fashion.

As described previously, the present apparatus and system is based upon the use of the agitator plate 10 reciprocated in a fluid to be mixed. The plate 10 of the present invention is constructed of a sturdy and typically corrosive resistant material, such as a stainless steel. The plate 10 includes at least one, and preferably a pair 12 and 14 of apertures or openings, these formed therethrough between opposite facing end faces 16 and 18 of the plate 10, and which are referenced in phantom outline in each of FIGS. 1 and 3.

A pair of displaceable valves 20 and 22 are mounted in translatable and overlapping fashion relative to the openings 12 and 14. The valves 20 and 22 are also known as a trapdoor valve or flapjack valves and operate to allow fluid to pass through the plate 10 in a first linearly actuating direction, while blocking the flow of fluid in a second opposite direction.

The valves 20 and 22 exhibit any desired flattened and arcuate outline (preferably consistent with the underlaying outline pattern of the aperture being covered) and are fabricated from a polymer, such as PTFE, in a preferred embodiment but are understood as also being capable of being constructed from any suitable material exhibiting the necessary properties of durability during reciprocating use, as well as seal-ability when engaging against the surface 16 of the plate 10 in an overlapping fashion relative to the arcuate pattern apertures 12 and 14 and as is evidenced by the outlines of FIGS. 1 and 3.

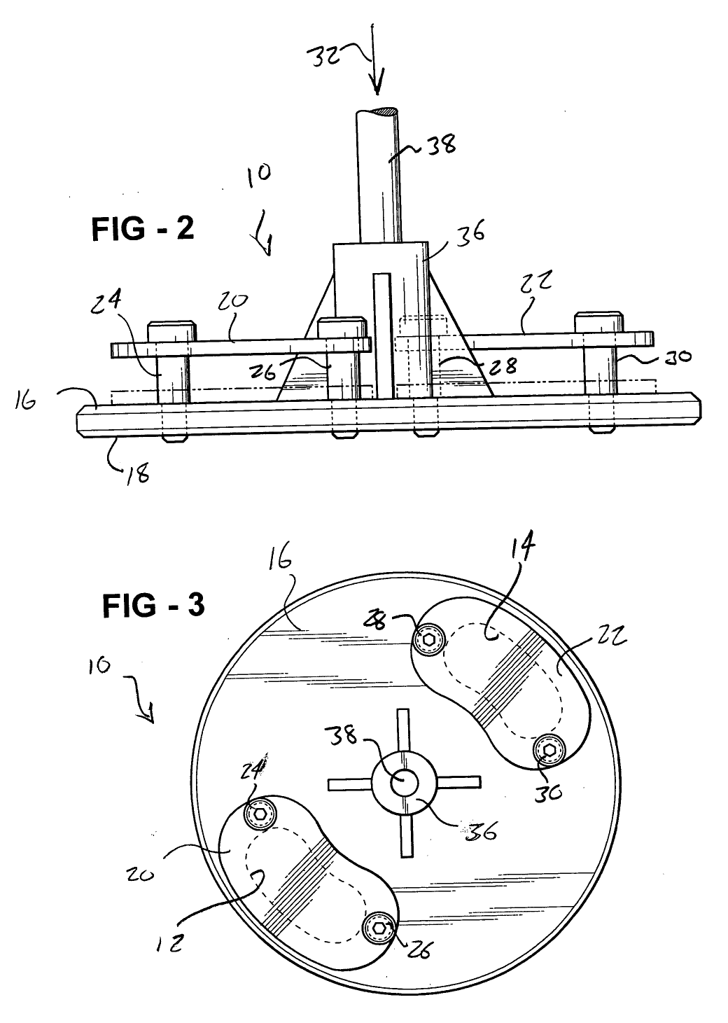

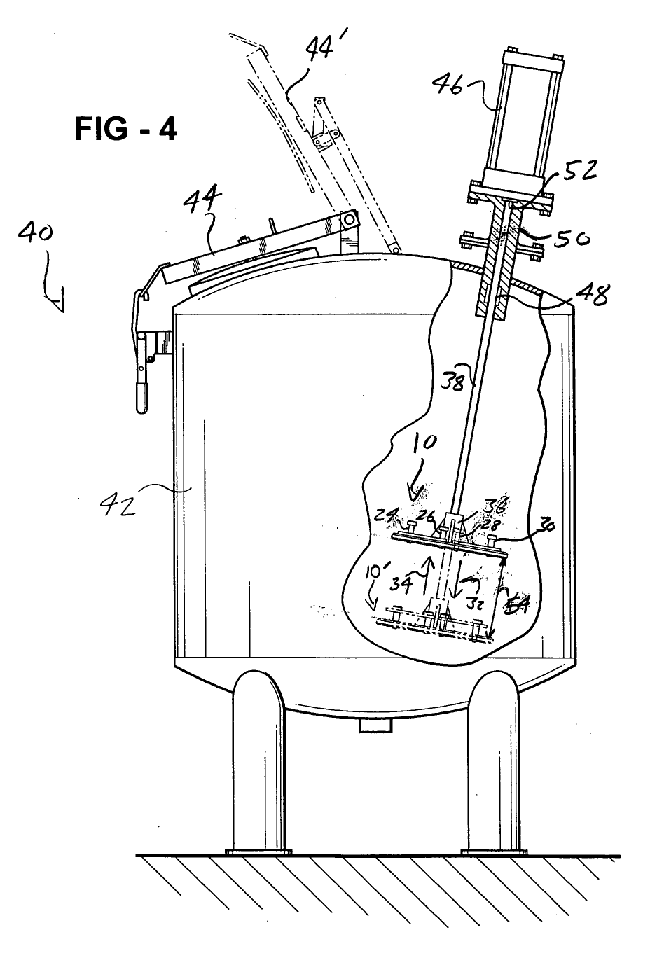

The degree of travel of the valves 20 and 22, relative to their associated plate openings 12 and 14, is dictated by respective pairs 24 & 26 and 28 & 30 of guiding bolts mounted in extending fashion from the upper face 16 of the plate 10. Each of the bolts terminates in an enlarged head portion which, during reciprocating motion, define displaced and unseating locations of the valves 20 and 22 relative to the openings 12 and 14 of the plate 10 in a first downward linear stroke (see arrow 32 in FIGS. 2 and 4), this further allowing for fluid passage through the apertures during this linear stroke. Although not clearly shown, the valves 20 and 22 include apertures which permit them to be mounted in linearly displaceable fashion along the fixed bolts.

Upon an opposite and retracting stroke (as further referenced by arrow 34 in FIG. 4) the valves 20 and 22 are caused to translate along the bolts 24 & 26 and 28 & 30 and to reseat upon the plate surface 16 and over the patterned apertures 12 and 14 (see again FIG. 1), thereby preventing fluid passage through the apertures and to create the desired agitating effect.

The plate includes a socket 36 configured to be mounted onto an extending shaft 38. In the illustrated embodiment, the plate 10 is approximately 10 inches in diameter; however, it is to be understood that the size of the plate will depend upon a particular application. In general, plates used in the present invention will have a diameter in the range of 4-15 inches. Also, it is to be understood that while the plate of FIGS. 1 and 2 is shown as being circular in cross-section, the plate may be otherwise configured so as to add a regular or irregular shape.

Referring finally to FIG. 4, there is illustrated one installation of the system according to the present invention. The system 40 includes a vessel 42, which is typical of paint retaining tanks utilized in industrial painting systems and which exhibits a hermetically sealed interior volume accessible through a spring-loaded and openable/closable cap, see as referenced at 44, and which is openable (at 44′) in order to access the vessel interior for adding or subtracting fluid therefrom.

Disposed in the vessel is the agitator plate 10 and assembly, generally similar to that described with reference to FIGS. 1-3. The plate is mounted onto the shaft 38, which in turn is reciprocated by a motor 46, which in the illustrated variant is a pneumatic motor.

It is also understood that hydraulic motors or other fluid operated motors may be similarly employed, as may be electric motors, manually operable/reciprocating mechanisms, and the like. As further noted, the system includes bushings, seals and bearings, as is conventional in the art.

Also, and as shown in FIG. 4, the shaft 38 is mounted at the upper end to a coupling 48 which is reciprocally mounted within an elongated housing 50 secured such as through an upper wall location of the vessel 42, such that the shaft is permitted a range of linear travel terminating at an upper location 52.

In the operation of the system of the present invention, paint is disposed in the tank 42, and the motor 46 operated so as to reciprocate the plate between valve closed 10 and opened 10′ configurations within the volume of the fluid being agitated. As is shown in FIG. 4, the motor 36 is operative to move the plate 10 in a stroke, as illustrated by directional arrow 54 and which, according to one variant, is approximately 8 inches in stroke.

The path of travel (or distance of linear stroke) is variable according to the preferences of one of ordinary skill in the art and in order to be generally adequate for most paint mixing operations. In general, the operation range of the mixture will depend upon the particular geometry of the mixing systems; however, typical ranges of travel are approximately 4-15 inches.

The speed of travel is selected so that sloshing or other aeration does not occur, and which may result from any resident air existing within a sealed container, or air which may be drawn into a defectively sealed container through internal vacuum or other negative pressurization. The present invention is also suitable for use with other non-hermetically sealed viscous fluid holding mediums and, in general, the speed of travel of the plate will be in the range of 0.1-10 inches per second.

In the illustration of FIGS. 1-4, the plate is shown as having two openings and two valves. The valves are constructed so that that they open and close in synchrony; that is to say, they both open when the plate moves in a first direction and both close when it moves in a second direction.

In particular applications, a larger or smaller number of openings and valves may be desired and, in those instances where multiple valves are employed, the present invention further contemplates reconfiguring selected valves so that they may be disposed to variously operate in opposite modes of action. That is to say, one valve may be open when the plate is traveling in a first direction while a second valve may be closed. This may be further assisted through the use of springs or other biasing structure for counteracting the resistive forces of the resident fluid in a given travel direction. By so selecting the number, placement and operational modes of the valves, various stirring actions can be achieved.

As is seen from FIG. 4, the agitator plate 10 is relatively small in cross-sectional area, as compared to the cross-sectional area of the vessel 42. In general, it has been found that utilizing a plate having a relatively small dimension minimizes sloshing, splashing, foaming or other aeration events. In general, it is desirable that the cross-sectional area of the plate be less than the average cross-sectional area of the vessel, this further being a necessity in order to allow the linear travel of the plate 10 within the vessel 42.

As shown in FIG. 4, the vessel is a generally right cylindrical vessel; therefore, its cross-sectional area is relatively constant along its height. In other instances, spherical vessels, tapered vessels, or the like, may be employed. In such instances, the diameter of the agitator plate may be approximately similar to the diameter of some portions of the vessel; however, in accord with the present invention, the size of the plate is selected so that its cross-sectional area is less than the average cross-sectional area of the vessel, again in order to permit it to linearly reciprocate over some specified range.

In specific instances, the cross-sectional area of the plate is no more than 80% of the average cross-sectional area of the vessel. In other instances, it is no more than 50% of the average cross-sectional area of the vessel. As again illustrated in FIG. 4, the cross-sectional area of the plate is less than 10% of the average cross-sectional area of the vessel and this relatively large difference in respective areas does not overcome the effectiveness of the assembly.

As is illustrated in FIG. 4, a single plate is disposed in the fluid. That said other implementations of the present invention are contemplated, by which a plurality of plates may be employed. The plates may be disposed on a single shaft, either in series, or in parallel, or they may be disposed on separate shafts. All such modifications and variations are within the scope of the present invention.

In view of the drawings and discussion presented herein, yet other modifications and variations of the invention will be apparent to those of skill in the art. In particular, it is also envisioned that the actuator plate with displaceable one-way valves, shaft and drive, may also be provided as a separate unit capable of being retrofitted with an existing volume holding vessel, paint can or the like.

The foregoing is illustrative of the invention and not a limitation upon the practice thereof. It is the following claims, including all equivalents, which define the scope of the invention.

I claim:

1. A non-aerating agitator system for mixing fluids, said system comprising:
a vessel which defines an interior volume for receiving a fluid therein;
an agitator plate having an opening therethrough, which opening has a one- way valve associated therewith, said one-way valve being operable to allow fluid to pass through said opening in a first direction, but not in a second direction opposite said first direction; and
a reciprocating drive for sequentially moving said plate in said first direction and said second direction.

2. The system of claim 1, wherein said plate has a cross-sectional area which is less than the average cross-section area of the vessel.

3. The system of claims 1-2, wherein said plate has a cross-sectional area which is no more than 80% of the average cross-sectional area of the vessel.

4. The system of claims 1-3, wherein the plate has a cross-sectional area which is no more than 50% of the average cross-sectional area of the vessel.

5. The system of claims 1-4, wherein said plate includes a second opening therethrough, which second opening has a second one-way valve associated therewith.

6. The system of claim 5, wherein said second one-way valve is operable to allow fluid to pass through said opening in said first direction, but not in said second direction.

7. The system of claim 5, wherein said second one-way valve is operable to allow fluid to pass through said second opening in said second direction, but not in said first direction.

8. The system of claims 1-6 wherein said reciprocating drive includes a fluid operated motor for moving said plate in said first and said second direction.

9. The system of claim 7, wherein said fluid operated motor is a pneumatic motor.

10. The system of claims 1-8, wherein said agitator plate has a diameter in the range of 4-15 inches.

11. The system of claims 1-9, wherein said reciprocating drive moves said plate along a path of travel having a stroke in the range of 4-15 inches.

12. The system of claims 1-10, wherein said reciprocating drive moves said plate at a rate of travel in the range of 0.1-10 inches per second.

13. An agitator for use with a fluid holding container, comprising:
a substantially plate shaped article exhibiting a specified thickness with first and second opposite surfaces, at least one opening being defined through a thickness of said plate and defined by an inwardly extending and enclosed outline;
a valve displaceably mounted over said opening and selectively overlapping said enclosed outline; and
a stem connecting to said valve at a first end and to a reciprocating drive mechanism at a second end for sequentially moving said plate in a first linear direction and a second opposite direction;
said valve unseating from said opening and operable to allow fluid to pass through said opening during linear translation in said first direction, said valve displacing to abut against said plate and to seal said opening in a second opposite linear translating direction, thereby preventing fluid flow through said opening and resulting in internal and non-aerating agitation of the fluid.

14. The agitator as described in claim 13, said plate having a specified shape and size and including at least first and second enclosed outline defining openings.

15. The agitator as described in claim 14, further comprising a pair of first and second valves displaceably mounted over said first and second openings.

16. The agitator as described in claim 13, further comprising a pair of guiding bolts extending from said plate in proximity to said outline defining opening, said valve mounting to said bolts in order to define a range of linear travel direction relative to said plate.

17. The agitator as described in claim 13, said valves each having a specified shape and size and being constructed of a polymer material.

18. The agitator as described in claim 16, said plate and guiding bolts having a specified shape and size and each being constructed of a stainless steel material.

19. The agitator as described in claim 13, said reciprocating drive mechanism further comprising a pneumatically operated motor.

20. A non-aerating agitator system for mixing at least one fluid held within a vessel, said system comprising:
the vessel defining an interior volume for receiving and holding a fluid therein;
an agitator plate having at least one opening therethrough, said opening having a one-way valve associated therewith and which is operable to allow fluid to pass through said opening in a first direction, but not in a second direction opposite said first direction; and
a reciprocating drive for sequentially moving said plate in said first direction and said second direction and in order to agitate the fluid during a given travel direction consistent with said valve being in a closed position relative to said plate.
